(19) United States
(12) Patent Application Publication
(10) Pub. No.: US 2004/0055886 A1
(43) Pub. Date: Mar. 25, 2004

(54) Electrochemical sensor for measuring the concentration of nitrogen oxides

(76) Inventor: Werner Gruenwald, Gerlingen (DE)

Correspondence Address: KENYON & KENYON, ONE BROADWAY, NEW YORK, NY, 10004, US

(21) Appl. No.: 10/620,963

(22) Filed: Jul. 15, 2003

(30) Foreign Application Priority Data
Jul. 17, 2002 (FR) 102 32 355.0-52

(51) Int. Cl. G01N 27/26

(52) U.S. Cl. 204/426; 204/428

(57) ABSTRACT

An electrochemical sensor is provided for measuring the concentration of nitrogen oxides in a gas to be measured, in particular in the exhaust gas of internal combustion engines in motor vehicles, having a first pump cell which includes a solid electrolyte and a pair of electrodes situated thereon which are connected to a first pump voltage, and having a second pump cell situated downstream in the gas flow which includes a solid electrolyte and a pair of electrodes situated thereon which are connected to a second pump voltage. To achieve an easily manufactured, more economical design of the sensor, for the electrodes in a first pump cell, the first electrode is exposed to the exhaust gas and the second electrode is exposed to a reference gas, and for the electrodes in a second pump cell, the first electrode is exposed to the gas volume leaving the first pump cell and the second electrode is also exposed to the reference gas. A Nernst cell for regulating the pump voltage at the first pump cell is thereby dispensed with, and the sensor may be used at the same time for measuring the oxygen concentration in the gas to be measured.

### FIELD OF THE INVENTION

The present invention relates to an electrochemical sensor for measuring the concentration of nitrogen oxides in a gas to be measured, in particular in the exhaust gas of internal combustion engines in motor vehicles.

### BACKGROUND INFORMATION

In one sensor, described in e.g., European Patent No. 678 740, the first electrodes of both pump cells are each situated in an inner chamber, the first inner chamber being acted on by the gas to be measured via a first diffusion barrier, and the second inner chamber being connected to the first inner chamber via a second diffusion barrier. Also situated in the first inner chamber is a measurement electrode or Nernst electrode which forms a Nernst cell with the reference electrode situated in the reference gas channel. On the exterior of the solid electrolyte the second electrode in the first pump cell is exposed to the gas to be measured. A pump voltage or direct-current voltage is applied to the first pump cell, and is regulated by the voltage produced in the Nernst cell due to the difference in concentration between the first inner chamber and the reference gas channel. The regulated pump voltage at the first pump cell is used to produce an oxygen partial pressure of constant value in the first inner chamber. The first electrode in the first inner chamber is made of catalytically inert material, and the pump voltage at the first pump cell is set so that the nitrogen oxides entering the first inner chamber do not decompose. The gas volume in the first inner chamber is introduced into the second inner chamber via the second diffusion barrier. The first electrode in the second pump cell is made of catalytically active material, and a constant pump voltage or direct-current voltage is applied to the second pump cell. The nitrogen oxides decompose in the second inner chamber, and the released oxygen ions are pumped from the second inner chamber by the pump voltage. The pump current flowing through the second pump cell, which is measured, is a measure of the concentration of nitrogen oxides in the gas to be measured.

### SUMMARY

One example embodiment of a sensor according to the present invention may have the advantage that the first pump cell pumps the oxygen into the reference gas instead of into the gas to be measured as the result of positioning the second electrode in the first pump cell in the reference channel. The Nernst cell present in the described conventional sensor may thus be dispensed with for regulating the pump voltage at the first pump cell. The design of the sensor is simplified, resulting in lower manufacturing costs. The pump current flowing through the first pump cell has an essentially linear dependence on the oxygen concentration in the gas to be measured, so that it is possible to use the sensor, using the pump current through the first pump cell as a signal current, to also measure the oxygen concentration in the gas to be measured.

According to one advantageous embodiment of the present invention, the first electrodes of both pump cells are each situated in a first and second inner chamber, the first inner chamber being connected to the gas to be measured and the second inner chamber being connected to the first inner chamber. The diffusion path associated with the first electrode in the first pump cell is formed in the first inner chamber.

According to one advantageous embodiment of the present invention, the diffusion path is formed by the first electrode in the first pump cell itself, which fills the entire first inner chamber. This measure contributes to reduced production costs and a low overall height for the sensor.

In one alternative embodiment of the present invention, a diffusion channel situated in the first inner chamber may be provided as the diffusion path and optionally may be filled with a porous diffusion agent.

In one advantageous embodiment of the present invention, a diffusion path upstream from the first electrode in the second pump cell is omitted, and a cavity is situated between the first inner chamber and the second inner chamber in which the gas volume leaving the first inner chamber is homogenized with respect to its gas component concentration. The cavity, in which a generally constant partial pressure is established, is used as a gas reservoir for the second pump cell from which gas is continuously pumped via the second pump cell.

In one preferred embodiment of the present invention, the cavity is dispensed with altogether, and the second inner chamber directly joins the first inner chamber. The first electrode in the first pump cell is then dimensioned in such a way that a constant, sufficiently low oxygen concentration is achieved at the interface between the first and second inner chamber. In both cases the first electrode in the second pump cell completely fills the second inner chamber. Alternatively, however, a diffusion channel may be provided in the second inner chamber—as in the first inner chamber—which may be filled with diffusion agent.

According to one advantageous embodiment of the present invention, a generally constant direct-current voltage is present at the first pump voltage which is high enough to prevent decomposition of the nitrogen oxides at the first electrode, which is made of catalytically inert material such as platinum and gold, in the first inner chamber. The voltage present at the second pump cell is significantly higher, so that the nitrogen oxides decompose at the first electrode, which is made of catalytically active material such as platinum, in the second inner chamber, and the oxygen thus released is pumped into the reference gas channel. The pump current flowing through the second pump cell is a measure of the residual oxygen and nitrogen oxides concentrations in the gas to be measured. The concentration of nitrogen oxides in the gas to be measured is determined by subtracting the residual oxygen concentration, which is measurable using the pump current in the first pump cell.

It has been shown that, in order to make a highly accurate determination of the concentration of nitrogen oxides in the gas to be measured, it may be necessary to hold the oxygen equilibrium concentration constant within very narrow bounds at the interface between the first and second inner chamber, since the oxygen equilibrium concentration is subject to certain, albeit small, fluctuations, depending on the oxygen concentration in the gas to be measured. In order to achieve this, according to one preferred embodiment of the present invention the pump voltage at the first pump cell is adjusted to the oxygen concentration in the gas to be measured.

According to one advantageous embodiment of the present invention, a characteristics map of the pump current flowing through the first pump cell as a function of the oxygen concentration is stored along with the pump voltage as a parameter. The pump current flowing through the first pump cell is measured and, using the measured value, the instantaneous change in the oxygen concentration is read from the characteristics map. The variable for the change in the voltage is calculated from the ratio of the change in concentration to the oxygen concentration in the gas to be measured.

### BRIEF DESCRIPTION OF THE DRAWINGS

The present invention is described in greater detail below, with reference to one exemplary embodiment illustrated in the drawings.

FIG. 1 shows a longitudinal section of a sensor, schematically illustrated.

FIG. 2 shows an illustration of a modified sensor, similar to that of FIG. 1.

FIG. 3 shows a diagram of the progression of the oxygen concentration over the length of the first electrodes in two successively positioned pump cells in the sensor according to FIG. 1.

FIG. 4 shows a diagram of the pump current flowing through the first pump cell in the sensor according to FIG. 1 as a function of the concentration of the oxygen in the gas to be measured.

FIG. 5 shows a diagram of the progression of the oxygen concentration over the length of the first electrode in the first pump cell for two different oxygen concentrations in the gas to be measured and two different pump voltages at the first pump cell.

FIG. 6 shows an enlarged section VI from the diagram shown in FIG. 5.

### DESCRIPTION OF THE EXEMPLARY EMBODIMENT

The electrochemical sensor, schematically illustrated in FIG. 1, for measuring the concentration of nitrogen oxides in a gas to be measured, preferably in the exhaust gas of internal combustion engines in motor vehicles, has a gas-sensitive sensor element 10, the basic structure of which is illustrated in cross section in FIG. 1. Sensor element 10 is usually housed in a sensor housing which is inserted in the exhaust pipe of an internal combustion engine in such a way that sensor element 10 is exposed to the exhaust gas of the internal combustion engine.

Sensor element 10, which is designed using the planar film technique, has, for example, multiple solid electrolyte layers 11. Solid electrolyte layers 11 are designed as ceramic films and form a planar ceramic body. The integrated shape of the planar ceramic body is produced by laminating together the ceramic films, which are imprinted with functional layers, and subsequently sintering the laminated structure. Each of the solid electrolyte layers is produced from a solid electrolyte material, such as yttrium-stabilized zirconium oxide (ZrO₂), for example, which conducts oxygen ions.

Sensor element 10 includes a first pump cell 12 which is connected to a constant—and in a refinement of the embodiment, adjustable within limits—direct-current voltage, referred to below as pump voltage U₁, and a second pump cell 13 which is connected to a constant direct-current voltage, referred to below as pump voltage U₂. Each pump cell 12 or 13 includes a pair of electrodes connected to pump voltage U₁or U₂ which are situated on a solid electrolyte. Two inner chambers 14, 15 are formed in a very thin solid electrolyte layer 11b situated between upper solid electrolyte layer 11a and subsequent solid electrolyte layer 11c, first inner chamber 14 having a gas inlet opening 24 to the environment of the gas to be measured, and second inner chamber 15 being connected to first inner chamber 14 via a cavity 16. The environment of the gas to be measured is symbolized by a flow arrow 27 in FIG. 1. In solid electrolyte layer lid following in the layer compound, a reference gas channel 17 is formed which is acted on by a reference gas 17 and which for example is connected to the ambient air. A resistance heater 18 is situated between the two lower solid electrolyte layers lie and 11f which is embedded in electrical insulation 19 made of aluminum oxide (Al₂O₃), for example. Resistance heater 18, which is connected to a heater voltage, extends over both inner chambers 14, 15, so that these are heated to approximately the same temperature level.

Of the two electrodes of first pump cell 12, a first electrode 20 is situated in first inner chamber 14 and completely fills it. First electrode 20 is designed in such a way that it forms a diffusion path for the gas to be measured entering inner chamber 14. First electrode 20 is manufactured from catalytically inert material, for example platinum and gold. Second electrode 21 of first pump cell 12 is situated in reference gas channel 17. First pump cell 12 is thus connected to pump voltage U₁ in such a way that its higher potential is present at second electrode 21.

Of the two electrodes of second pump cell 13, first electrode 22 is situated in second inner chamber 15 and completely fills it. The first electrode is manufactured from catalytically active material, for example platinum. Second electrode 23 of second pump cell 13 is likewise situated in reference gas channel 17. Pump cell 13 is connected to pump voltage U₂ in such a way that its higher potential is present at second electrode 23. Both second electrodes 21, 23 of both pump cells 12, 13 in reference channel 17 are combined into a uniform electrode layer which extends over the entire length of both successively positioned inner chambers 14, 15 and of reference gas channel 17.

If pump voltage U₁, for example 150 mV, is switched on to first pump cell 12, a pump current I₁ flows through first pump cell 12, and a constant oxygen partial pressure, i.e., a constant oxygen concentration, is established at the end of first inner chamber 14 by pumping oxygen ions from first inner chamber 14 into reference channel 17.

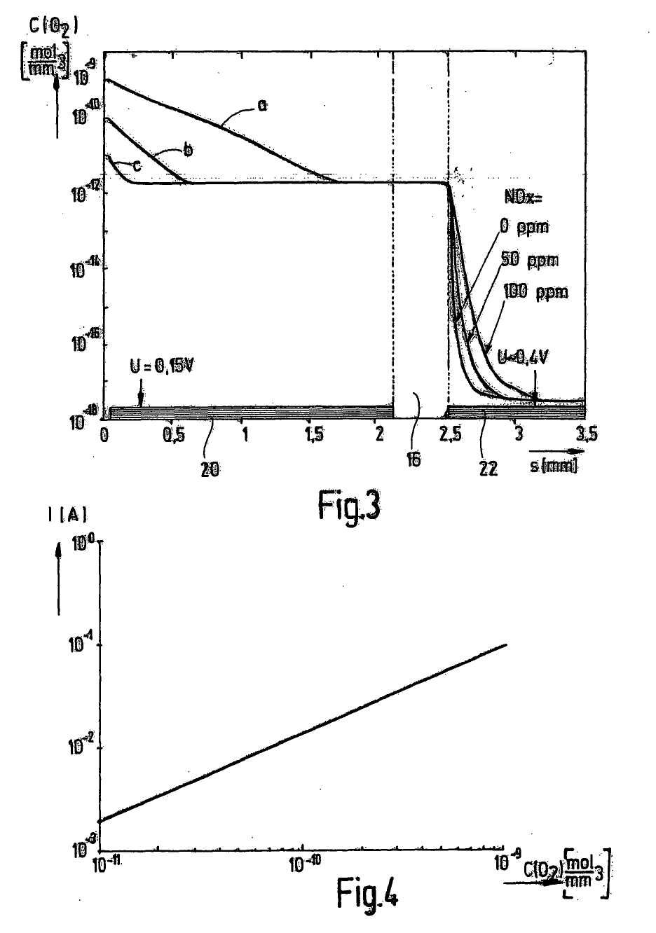

FIG. 3 illustrates the progression of oxygen concentration C in first inner chamber 14 over the length of first electrode 20 of first pump cell 12 for three different oxygen concentrations in the gas to be measured, i.e., the exhaust gas. As an example, curve a shows the progression for an oxygen concentration of 10⁻⁹ mol/mm³ in the gas to be measured, curve b for an oxygen concentration of 10⁻¹⁰ mol/mm³ in the gas to be measured, and curve c for an oxygen concentration of 10⁻¹¹ mol/mm³. As seen in FIG. 3, the oxygen equilibrium concentration of 1000 ppm, for example, associated with pump voltage U₁ with respect to reference gas (air) is established in the back region of first electrode 20. The small pump voltage U₁ of just 150 mV, for example, and the catalytically inert material of first electrode 20 at higher pump voltages prevent the nitrogen oxides from decomposing in inner chamber 14. This end oxygen concentration of 1000 ppm, for example, is established in cavity 16 connected downstream, which in the embodiment has the same cross section in the direction of flow of the gas volume as the two inner chambers 14, 15 but may be made several times larger in cross section.

If constant pump voltage U₂, which is significantly higher than pump voltage U₁ at first pump cell 12, for example 400 mV, is applied to second pump cell 13, gas is continuously pumped out of cavity 16 in second pump cell 12 and into second inner chamber 15. At this high pump voltage U₂ and under the catalytic effect of the catalytically active material of first electrode 22 of second pump cell 13, the nitrogen oxides decompose in second inner chamber 15, and the released oxygen ions are pumped into reference gas channel 17 via solid electrolyte layer 11c.

FIG. 3 illustrates the progression of oxygen concentration C over length s of first electrode 22 of second pump cell 13, for three different concentrations of nitrogen oxides in the gas to be measured, which in FIG. 3 are given as 0 ppm, 50 ppm, and 100 ppm as examples. Pump current I₂ flowing through second pump cell 13 is a measure of the nitrogen oxides concentration, including a constant residual oxygen concentration R (FIG. 1). The latter is subtracted to determine only the nitrogen oxides concentration in the gas to be measured.

FIG. 4 illustrates pump current I₁ which flows through first pump cell 12 as the result of pumping the oxygen from inner chamber 14 into reference gas channel 17, as a function of oxygen concentration C in the gas to be measured. It shows that pump current I₁ has a generally linear dependence on oxygen concentration C, so that it is also possible to use the sensor for measuring the oxygen concentration in the gas to be measured.

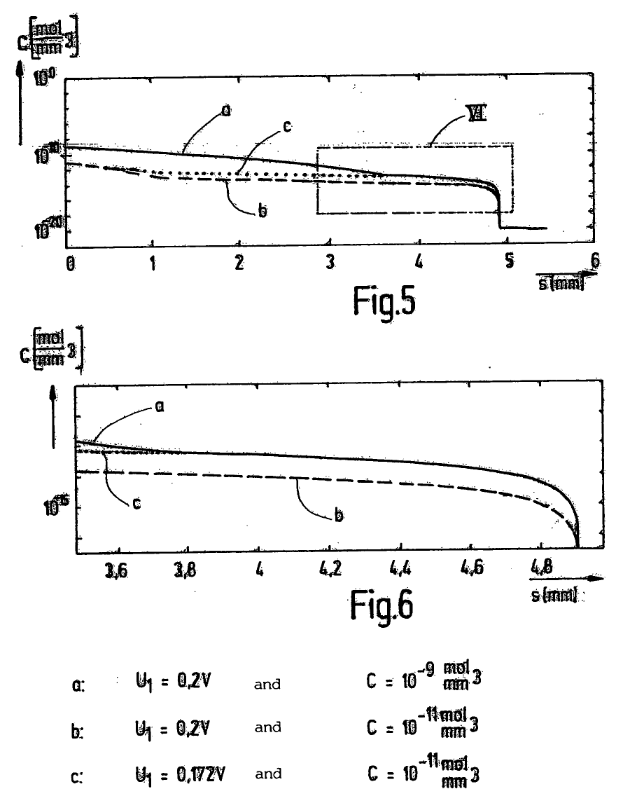

It has been shown that the equilibrium concentration of oxygen established in cavity 16 is not absolutely constant, but instead fluctuates, albeit within narrow bounds, as a function of the oxygen concentration in the gas to be measured. FIG. 5 illustrates the progression of oxygen concentration C over length s of first electrode 20 in first inner chamber 14 for a concentration C=10⁻⁹ mol/mm³ and a pump voltage U₁=0.2 V (curve a), and for a concentration C=10⁻¹¹ mol/mm³ and a pump voltage U₁ which is also 0.2 V (curve b). The curve progression is illustrated in FIG. 6 for enlarged region VI in FIG. 5. It is evident that changing the oxygen concentration in the gas to be measured also results in a change, albeit small, in the oxygen equilibrium concentration at the end of first electrode 20 and in cavity 16. Consequently, pump current I₂ flowing in second pump cell 13 is no longer precisely constant with respect to portion R which results from the residual oxygen concentration, but instead is dependent on the oxygen concentration in the gas to be measured, so that the measured concentration of nitrogen oxides is somewhat distorted.

To ensure a highly precise measurement, pump voltage U₁ at first pump cell 12 is modified as a function of the oxygen concentration in the gas to be measured, and thus as a function of pump current I₁ flowing through first pump cell 12. To this end, a characteristic map is used in which pump current I₁ flowing through first pump cell 12 as a function of oxygen concentration C in the gas to be measured, along with pump voltage U₁, is stored as a parameter. Pump current I₁ flowing through first pump cell 12 is measured, and, using the measured value, instantaneous change ΔC in the oxygen concentration is read from the characteristics map. The variable for the required change in voltage ΔU is calculated from the ratio of change in concentration ΔC to concentration C of oxygen in the gas to be measured, according to

$$Δ U = K \cdot \frac{Δ C}{C}$$

where constant K is estimated from the Nernst equation. For each decade by which the concentration of oxygen in the gas to be measured changes, the ratio is ΔC/C=0.9.

In the example shown in FIGS. 5 and 6, the change in concentration between curves a and b is 10⁻² mol/mm³, and the concentration is thus changed by two decades. If, for example, a voltage reduction ΔU of 2·(−0.014) V=−0.028 V occurs during a drop in concentration from 10⁻⁹ to 10⁻¹¹ mol/mm³, this results in curve c which generally coincides with the region of curve a. As a result of this voltage reduction ΔU, the oxygen concentration in the end region of first electrode 20 of first pump cell 12 remains absolutely constant, and shows no dependence whatsoever on the concentration of oxygen in the gas to be measured. Thus, current portion R contained in pump current I₂ in second pump cell 13, which is the result of the oxygen concentration present in cavity 16, is also constant, and the nitrogen oxides concentration may be determined very precisely by subtracting this constant current portion R.

When pump voltage U₁ present at first pump cell 12 is thus adjusted to the change in oxygen concentration in the gas to be measured, it is possible to dispense with cavity 16 between the two inner chambers 14, 15 for homogenizing the gas volume leaving first inner chamber 14 with respect to its gas component concentration, and the layout of the electrodes may be designed so that the two inner chambers 14, 15 may merge directly into one another.

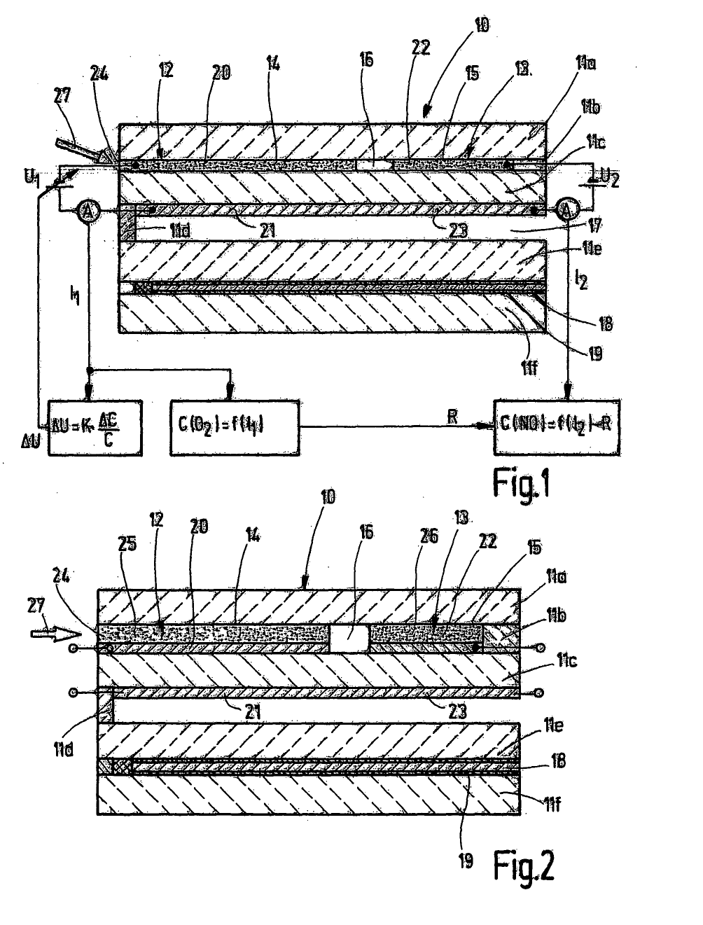

In one modification of sensor element 10 illustrated in FIG. 2, a diffusion path is situated upstream from each inner chamber 14, 15 of first electrode 20 or 22 in first pump cell 12 or in second pump cell 13, respectively. This diffusion path includes a diffusion channel 25 or 26 which may be filled with a porous diffusion material such as Al₂O₃, as shown in FIG. 2. When the diffusion material is omitted, diffusion channel 25 must be structurally designed so that, in spite of the unrestrained flow of gas to be measured into first inner chamber 14 via gas inlet opening 24, a sufficiently low, constant oxygen concentration results at the end of first electrode 20 in first pump cell 12.

What is claimed is:

1. An electrochemical sensor for measuring a concentration of nitrogen oxides in a gas to be measured in an exhaust gas of an internal combustion engine in a motor vehicle, comprising:
a first pump cell having a solid electrolyte which conducts oxygen ions;
a first pair of electrodes, situated on the first pump cell, which is connected to a first pump voltage, a first one of the first pair of electrodes being configured to be acted on by the gas to be measured via a diffusion path;
a second pump cell situated downstream from the first pump cell in a direction of gas flow and having a solid electrolyte which conducts oxygen ions; and
a second pair of electrodes, situated on the second pump cell, which is connected to a second pump voltage, a first one of the second pair of electrodes being configured to be exposed to a gas volume leaving the first pump cell, a second one of the second pair of electrodes being configured to be exposed to a reference gas;
wherein a second one of the first pair of electrodes of the first pump cell is configured to be exposed to the reference gas.

2. The sensor as recited in claim 1, wherein the first one of the first pair of electrodes is situated in a first inner chamber, and the first one of the second pair of electrodes is situated in a second inner chamber, the first inner chamber being connected to the gas to be measured, the second inner chamber being connected to the first inner chamber, and the diffusion path being formed in the first inner chamber.

3. The sensor as recited in claim 2, wherein the diffusion path is formed by the first one of the first pair of electrodes, which fills the entire first inner chamber.

4. The sensor as recited in claim 2, wherein the diffusion path is a diffusion channel in the first inner chamber which extends over the first one of the first pair of electrodes of the first pump cell.

5. The sensor as recited in claim 4, wherein the diffusion channel is filled with a porous diffusion material.

6. The sensor as recited in claim 1, wherein the first one of the first pair of electrodes of the first pump cell is made of catalytically inert material.

7. The sensor as recited in claim 2, wherein a cavity connected to the inner chamber is between the first inner chamber and the second inner chamber.

8. The sensor as recited in claim 7, wherein a cross section of the cavity is a multiple of a cross section of an opening into the first and second inner chambers in the cavity.

9. The sensor as recited in claim 2, wherein a diffusion path is situated upstream from the first one of the second pair of electrodes in the second pump cell.

10. The sensor as recited in claim 9, wherein the diffusion path is formed by the first one of the second pair of electrodes in the second pump cell which fills the entire second inner chamber.

11. The sensor as recited in claim 9, wherein the diffusion path is a diffusion channel extending in the second inner chamber over the first one of the second pair of electrodes of the second pump cell.

12. The sensor as recited in claim 11, wherein the diffusion channel is filled with a porous diffusion material.

13. The sensor as recited in claim 1, wherein the first pump voltage is a direct-current voltage whose value is selected so as to avoid decomposition of nitrogen oxides contained in the gas to be measured, and the second pump voltage is a constant direct-current voltage having a higher value than that of the first pump voltage.

14. The sensor as recited in claim 13, wherein the first pump voltage is configured to be adjusted to a change in the oxygen concentration in the gas to be measured.

15. The sensor as recited in claim 14, wherein the first pump voltage is adjusted in such a way that an oxygen concentration in the gas to be measured reaching the first one of the second pair of electrodes of the second pump cell is not influenced by the oxygen concentration in the gas to be measured.

16. The sensor as recited in claim 13, wherein a pump current flowing through the first pump cell as a function of the oxygen concentration is stored along with the first pump voltage as a parameter in a characteristics map, and the pump current flowing through the first pump cell is measured and, using the measured value, an instantaneous change in the oxygen concentration is read from the characteristics map, and a variable for the change in the voltage is calculated from the ratio of the change in concentration to the oxygen concentration in the gas to be measured.
